(19) United States
(12) Patent Application Publication
(10) Pub. No.: US 2024/0192324 A1
(43) Pub. Date: Jun. 13, 2024

(54) GRATING STRUCTURE AND LiDAR DEVICE INCLUDING THE SAME

(71) Applicant: SAMSUNG ELECTRONICS CO., LTD., Suwon-si (KR)

(72) Inventors: Woosung KIM, Suwon-si (KR); Hyunil BYUN, Suwon-si (KR)

(73) Assignee: SAMSUNG ELECTRONICS CO., LTD., Suwon-si (KR)

(21) Appl. No.: 18/206,310

(22) Filed: Jun. 6, 2023

(30) Foreign Application Priority Data
Dec. 7, 2022 (KR) 10-2022-0170053

(51) Int. Cl. G01S 7/481; G02B 5/18

(52) U.S. Cl. CPC G01S 7/4814; G02B 5/1861

(57) ABSTRACT

Provided is a grating structure including a grating layer including a first surface, a second surface opposite to the first surface, and a plurality of grating teeth between the first surface and the second surface, a slab layer on a surface of at least one of the plurality of grating teeth, and a heater on at least one of the first surface, the second surface, and the plurality of grating teeth.

### CROSS-REFERENCE TO RELATED APPLICATION

This application claims priority to Korean Patent Application No. 10-2022-0170053, filed on Dec. 7, 2022, in the Korean Intellectual Property Office, the disclosure of which is incorporated by reference herein in its entirety.

### BACKGROUND

### 1. Field

Example embodiments of the present disclosure relate to a grating structure and a light detection and ranging (LiDAR) device including the grating structure.

### 2. Description of Related Art

A multi-wavelength beam may transmit multiple pieces of information through multiplexing/demultiplexing. When a multi-wavelength beam is used in a sensor, a wide area may be sensed at the same time based on the emission angle characteristics according to wavelengths. As such, a multi-wavelength is considered as an important characteristic of light, and an echelle grating is an element for multiplexing/demultiplexing by using the characteristics of the emission angle according to the wavelength of a multi-wavelength beam.

### SUMMARY

One or more example embodiments provide a grating structure having improved thermal performance.

One or more example embodiments also provide an optical phased array device including a grating structure having improved thermal performance.

One or more example embodiments also provide a LIDAR device including a grating structure having improved thermal performance.

Additional aspects will be set forth in part in the description which follows and, in part, will be apparent from the description, or may be learned by practice of the presented embodiments of the disclosure.

According to another aspect of an example embodiment, there is provided a grating structure including a grating layer including a first surface, a second surface opposite to the first surface, and a plurality of grating teeth between the first surface and the second surface, a slab layer on a surface of at least one of the plurality of grating teeth, and a heater on at least one of the first surface, the second surface, and the plurality of grating teeth.

The heater may be on a portion of the first surface or a portion of the second surface in contact with the plurality of grating teeth.

The heater may include a plurality of heaters corresponding to the plurality of grating teeth, respectively.

The heater may be between the slab layer and the plurality of grating teeth.

The heater may include a coating layer that includes a dielectric material dividing the heater.

The heater may include nickel (Ni), tantalum (Ta), platinum (Pt), gold (Au), silver (Ag), titanium (Ti), aluminum (Al), copper (Cu), or tungsten (W). The heater may have a thickness equal to or less than 1.5 μm.

A refractive index of a material of the grating layer may be less than a refractive index of a material of the slab layer.

The grating layer may include an echelle grating.

According to another aspect of an example embodiment, there is provided an optical phased array device including a multiplexer configured to receive and multiplex light, a light distribution device configured to distribute the light passing through the multiplexer, a light modulator configured to modulate the multiplexed light distributed by the light distribution device, and an output device configured to receive light from the light modulator and simultaneously emit a plurality of output lights, wherein the multiplexer includes a grating layer including a first surface, a second surface opposite to the first surface, and a plurality of grating teeth between the first surface and the second surface, a slab layer on a surface of at least one of the plurality of grating teeth, and a heater on at least one of the first surface, the second surface, and the plurality of grating teeth.

The heater may be on a portion of the first surface or a portion of the second surface in contact with the plurality of grating teeth.

The heater may include a plurality of heaters corresponding to the plurality of grating teeth, respectively.

The heater may be between the slab layer and the plurality of grating teeth.

The multiplexer, the light distribution device, the light modulator, and the output device may be optically connected.

According to yet another aspect of an example embodiment, there is provided a light detection and ranging (LIDAR) device including a light source, a steering device, a detector, and a processor, wherein the steering device includes an optical phased array device that includes a multiplexer configured to receive and multiplex light from the light source, a light distribution device configured to distribute the light passing through the multiplexer, a light modulator configured to modulate the multiplexed light distributed by the light distribution device, and an output device configured to receive light from the light modulator and simultaneously emit a plurality of output lights, wherein the multiplexer includes a grating layer including a first surface, a second surface opposite to the first surface, and a plurality of grating teeth between the first surface and the second surface, a slab layer disposed on a surface of at least one of the plurality of grating teeth, and a heater on at least one of the first surface, the second surface, and the plurality of grating teeth of the grating layer.

The LiDAR device may further include a demultiplexer, wherein the demultiplexer is configured to demultiplex the light reflected from an object and divide the light into light having different wavelengths.

The heater may be on a portion of the first surface or a portion of the second surface in contact with the plurality of grating teeth.

The heater may include a plurality of heaters corresponding to the plurality of grating teeth, respectively.

The heater may be between the slab layer and the plurality of grating teeth.

The heater may include a coating layer, including a dielectric material, that divides the heater.

### BRIEF DESCRIPTION OF THE DRAWINGS

The above and other aspects, features, and advantages of example embodiments of the disclosure will be more apparent from the following description taken in conjunction with the accompanying drawings, in which:

FIG. 1 is a perspective view of a grating structure according to example an embodiment;

FIG. 2 is a perspective view of a grating structure according to another example embodiment;

FIGS. 3, 4, and 5 are perspective views of a grating structure according to another example embodiment;

FIG. 6 is a diagram illustrating diffraction according to temperature of light in a grating layer according to an example embodiment;

FIGS. 7A and 7B are diagrams illustrating diffraction according to a wavelength of light in a grating layer according to an example embodiment;

FIG. 8 is a diagram illustrating an example of temperature control in a demultiplexer according to an example embodiment;

FIG. 9 is a diagram illustrating an optical phased array device according to an example embodiment; and

FIG. 10 is a diagram showing a LIDAR device according to an example embodiment.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

A grating structure and a light detection and ranging (LiDAR) device including the grating structure will now be described in detail with reference to the accompanying drawings. In the drawings, like reference numerals refer to like elements throughout, and sizes of elements in the drawings may be exaggerated for clarity and convenience of explanation. The following embodiments described below are merely illustrative, and various modifications may be possible from the embodiments of the disclosure.

When an element or layer is referred to as being “on” or “above” another element or layer, the element or layer may be directly on another element or layer or intervening elements or layers. In the following embodiments, the singular forms include the plural forms unless the context clearly indicates otherwise. When a part “comprises” or “includes” an element in the specification, unless otherwise defined, it is not excluding other elements but may further include other elements.

In the specification the term “above” and similar directional terms may be applied to both singular and plural. With respect to operations that constitute a method, the operations may be performed in any appropriate sequence unless the sequence of operations is clearly described or unless the context clearly indicates otherwise. The operations may not necessarily be performed in the order of sequence.

Connections or connection members of lines between components shown in the drawings illustrate functional connections and/or physical or circuit connections, and the connections or connection members may be represented by replaceable or additional various functional connections, physical connections, or circuit connections in an actual apparatus.

All examples or example terms (for example, etc.) are simply used to explain in detail the technical scope of the disclosure, and thus, the scope of the disclosure is not limited by the examples or the example terms as long as it is not defined by the claims.

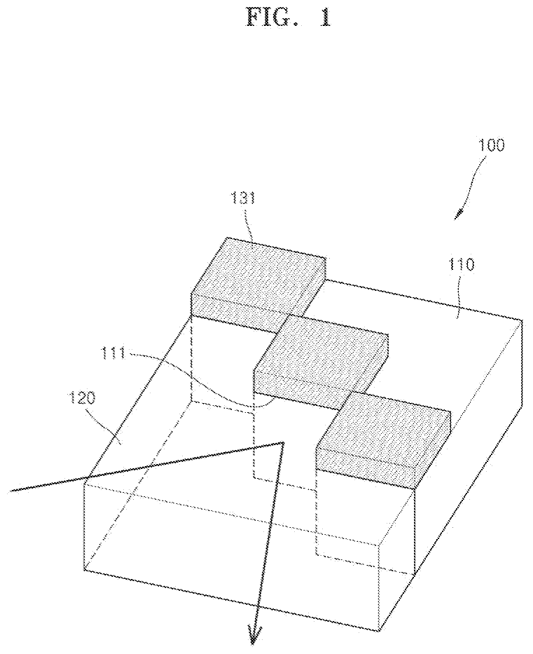

FIG. 1 is a perspective view of a grating structure 100 according to an example embodiment.

Referring to FIG. 1, the grating structure 100 may include a grating layer 110 including a first surface, a second surface opposite to the first surface, and a plurality of grating teeth disposed between the first surface and the second surface, a slab layer 120 facing a side surface of the grating teeth 111, and a heater 131 facing the first surface or the second surface of the grating layer 110.

The grating layer 110 may reflect light emitted from a light source and diffract the reflected light. The grating layer 110 may reflect and diffract light emitted from the light source through surfaces of a plurality of grating teeth 111. The diffraction angle of the reflected light may vary with the inclination of the grating teeth 111, period, height, refractive index, and wavelength of the incident light. Although only three grating teeth 111 are shown in FIG. 1 for convenience, the grating structure 100 may include a greater number of grating teeth 111 than three.

The grating layer 110 may include, for example, an echelle grating. The grating layer 110 may include a first surface and a second surface disposed opposite to the first surface. In FIG. 1, the first surface may be an upper surface of the grating layer 110 and the second surface may be a lower surface of the grating layer 110. The grating layer 110 may include a plurality of grating teeth 111 disposed between the first surface and the second surface. When the grating layer 110 includes an echelle grating, the plurality of grating teeth 111 may have different sizes and shapes. However, the grating layer 110 is not limited thereto and may include various other types of gratings, and the plurality of grating teeth 111 may have the same size and shape.

The grating layer 110 may include a material having a refractive index lower than a refractive index of a material constituting the slab layer 120. The grating layer 110 may include, for example, silicon oxide (SiO₂), silicon nitride (SiN), and the like. The grating structure 100 may operate as a multiplexer/demultiplexer by including the grating layer 110.

The slab layer 120 may be disposed on a side of the grating layer 110. The slab layer 120 may be as a waveguide through which light is transmitted in an optical circuit or optical device. The grating layer 110 may be disposed such that the grating teeth 111 are located in the waveguide.

The slab layer 120 may be optically coupled to the grating layer 110. The slab layer 120 may include an optical path of input light and an optical path of output light. The optical path of input light and the optical path of output light may be placed in the slab layer 120. The input light may propagate through a free propagation region (FPR) of the slab layer 120. The slab layer 120 may emit light reflected from the grating layer 110. The emitted light may propagate through the FPR of the slab layer 120.

The slab layer 120 may include a material having a refractive index greater than a refractive index of a material constituting the grating layer 110. The slab layer 120 may include, for example, silicon (Si). Because the slab layer 120 includes a material having a refractive index greater than a refractive index of a material constituting the grating layer 110, light incident on the grating layer 110 within the slab layer 120 may be totally reflected.

The heater 131 may be disposed on the first surface or the second surface of the grating layer 110. The heater 131 may be disposed on a region of the first surface or the second surface grating layer 110 that is in contact with the grating teeth 111.

The heater 131 may adjust a diffraction angle in the grating layer 110 by applying heat to the grating layer 110. For example, the heater 131 applies heat to the grating layer 110 to change the refractive index of the grating layer 110, and changes a diffraction angle in the grating layer 110 through the change in the refractive index of the grating layer 110.

The heater 131 may be disposed to contact the upper surface (first surface) of the grating layer 110. The heater 131 may directly contact the upper surface of the grating layer 110, but the heater 131 and the grating layer 110 may be disposed with a certain interval therebetween. The heater 131 may be formed in plural. The plurality of heaters 131 may be disposed to be in contact with the plurality of grating teeth 111 included in the grating layer 110. The plurality of heaters 131 may be disposed to correspond to each of the grating teeth 111. It may be difficult to obtain a desired diffraction angle at each of the grating teeth 111 by using only one heater 131. The plurality of heaters 131 are disposed to contact the plurality of grating teeth 111 of the grating layer 110, respectively, and each of the grating teeth 111 may be independently controlled. The plurality of heaters 131 may independently control each of the grating teeth 111 to more easily obtain a desired diffraction angle.

In FIG. 1, the plurality of heaters 131 are arranged at regular intervals in a rectangular parallelepiped shape, but embodiments are not limited thereto. The plurality of heaters 131 may include any shape and arrangement that allows each heater 131 to operate independently.

The heater 131 may include a metal material. The heater 131 may include, for example, nickel (Ni), tantalum (Ta), platinum (Pt), gold (Au), silver (Ag), titanium (Ti), aluminum (Al), copper (Cu), or, tungsten (W).

The heater 131 may have a thickness that shows an optimal thermal performance. When the heater 131 includes nickel (Ni), the heater 131 may have, for example, a thickness of about 75 nm. When the heater 131 includes gold (Au), the heater 131 may have, for example, a thickness of about 150 nm.

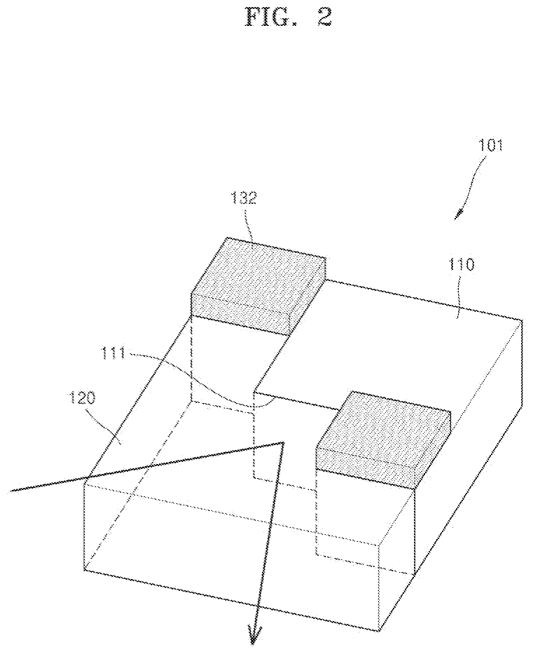

FIG. 2 is a perspective view of a grating structure 101 according to another example embodiment.

Referring to FIG. 2, the grating structure 101 may include a grating layer 110 including a first surface, a second surface opposite to the first surface, and a plurality of grating teeth 111 disposed between the first surface and the second surface, a slab layer 120 disposed to face a side surface of the grating teeth 111, and a heater 132 disposed to face the first surface or the second surface of the grating layer 110.

The grating layer 110 and the slab layer 120 may be the same as the grating layer 110 and the slab layer 120 of FIG. 1. In describing the grating structure 101 of FIG. 2, descriptions previously given with reference to FIG. 1 will be omitted.

The heater 132 may be formed in plural. The plurality of heaters 132 may be disposed to contact the plurality of grating teeth 111 of the grating layer 110. The plurality of heaters 132 may be disposed only on some of the grating teeth 111 among the plurality of grating teeth 111. The heater 132 may be the same as the heater 131 of FIG. 1 except that it may be disposed only on some of the grating teeth 111 among the plurality of grating teeth 111.

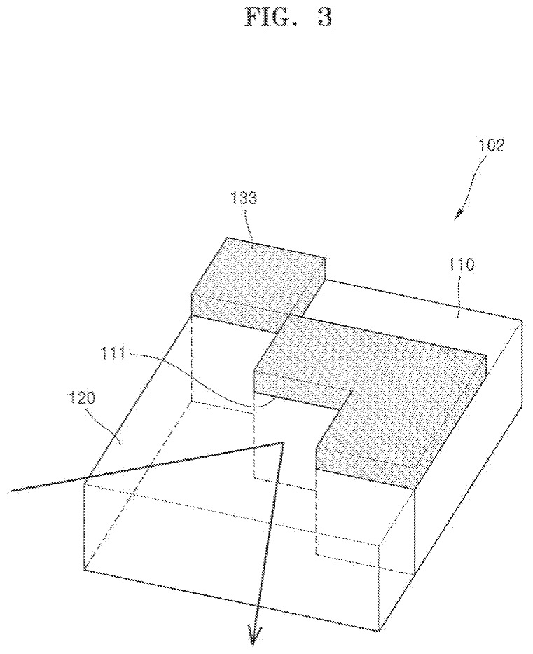

FIG. 3 is a perspective view of a grating structure 102 according to another example embodiment.

Referring to FIG. 3, the grating structure 102 includes a grating layer 110 including a first surface, a second surface opposite the first surface, and a plurality of grating teeth 111 disposed between the first surface and the second surface, a slab layer 120 disposed to face a side surface of the grating teeth 111, and a heater 132 disposed to face the first surface or the second surface of the grating layer 110.

The grating layer 110 and the slab layer 120 may be the same as the grating layer 110 and the slab layer 120 of FIG. 1. In describing the grating structure 102 of FIG. 3, descriptions previously given with reference to FIG. 1 will be omitted.

The heater 133 may be formed in plural. The plurality of heaters 133 may be disposed to be in contact with the plurality of grating teeth 111 of the grating layer 110. One heater 133 may be disposed on a plurality of grating teeth 111, and one heater 133 may be disposed on one grating tooth 111. The heater 133 may be disposed over the plurality of grating teeth 111, or may be disposed to correspond to each grating tooth 111. The heater 133 may be the same as the heater 131 of FIG. 1 except that it may be disposed across a plurality of grating teeth 111.

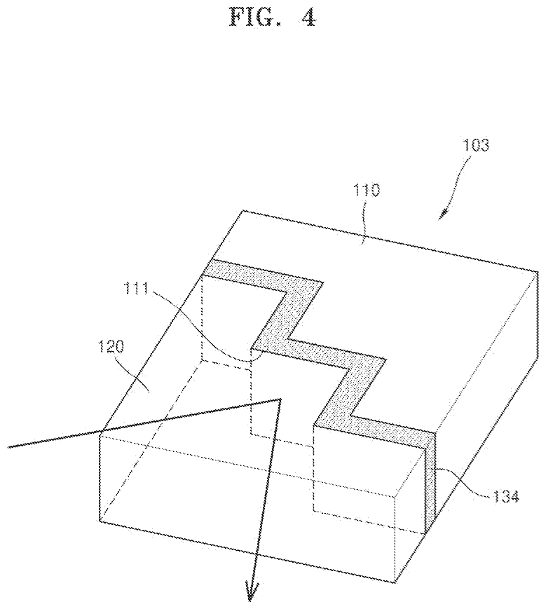

FIG. 4 is a perspective view of a grating structure 103 according to another example embodiment.

Referring to FIG. 4, the grating structure 103 includes a grating layer 110 including a first surface, a second surface opposite to the first surface, and a plurality of grating teeth 111 disposed between the first surface and the second surface, a slab layer 120 disposed to face a side surface of the grating teeth 111, and a heater 134 disposed to face the plurality of grating teeth 111.

The grating layer 110 and the slab layer 120 may be the same as the grating layer 110 and the slab layer 120 of FIG. 1. In describing the grating structure 103 of FIG. 4, descriptions previously given with reference to FIG. 1 will be omitted.

The grating structure 103 may include the heater 134 disposed between the slab layer 120 and the plurality of grating teeth 111. The heater 134 may be disposed on a side surface of the grating layer 110. The heater 134 may be disposed on a side surface of the grating layer 110 to reflect light incident on the grating layer 110. In particular, the heater 134 may be disposed along a surface of the grating teeth 111 of the grating layer 110 to constitute a part of the grating teeth 111. The heater 134 may be disposed so that light incident on the grating layer 110 is incident on the heater 134. The heater 134 is disposed on a side surface of the grating layer 110, applies heat to the grating layer 110 to adjust a diffraction angle in the grating layer 110, and simultaneously reflects light incident on the grating layer 110.

The heater 134 may have a thickness that shows an optimal thermal performance. When the heater 134 includes nickel (Ni), the heater 134 may have, for example, a thickness of about 75 nm. When the heater 134 includes gold (Au), the heater 134 may have, for example, a thickness of about 150 nm. The heater 134 may have a thickness that shows an optimal reflectivity. The heater 134 may have, for example, a thickness of about 2 μm or less. The heater 134 may have, for example, a thickness of about 1.5 μm or less.

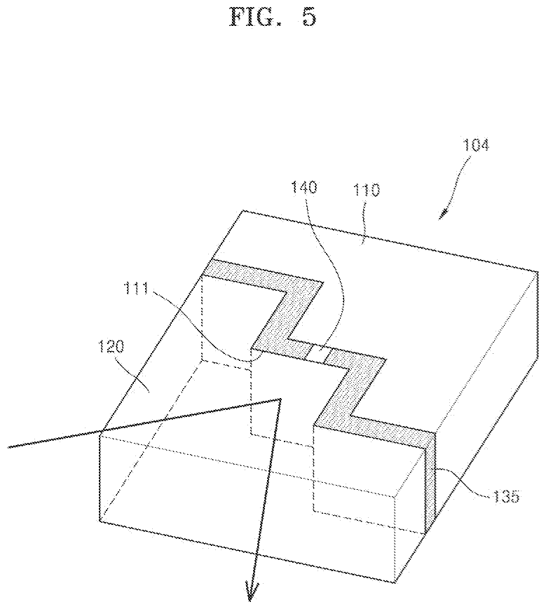

FIG. 5 is a perspective view of a grating structure 104 according to another example embodiment.

Referring to FIG. 5, the grating structure 104 includes a grating layer 110 including a first surface, a second surface opposite the first surface, and a plurality of grating teeth 111 disposed between the first surface and the second surface, a slab layer 120 disposed to face a surface of the grating teeth 111, and a heater 135 disposed to face the plurality of grating teeth 111.

The grating layer 110 and the slab layer 120 may be the same as the grating layer 110 and the slab layer 120 of FIG. 1. In describing the grating structure 104 of FIG. 5, descriptions previously given with reference to FIGS. 1 and 4 will be omitted.

The heater 135 may include a coating layer 140. The coating layer 140 may include a dielectric material. The coating layer 140 may include, for example, SiO₂ or SiN. The heater 135 may be divided into a plurality of heaters 135 by the coating layer 140. In this case, the plurality of heaters 135 operate independently to control the grating teeth 111 independently, thus, a desired diffraction angle may be more easily obtained.

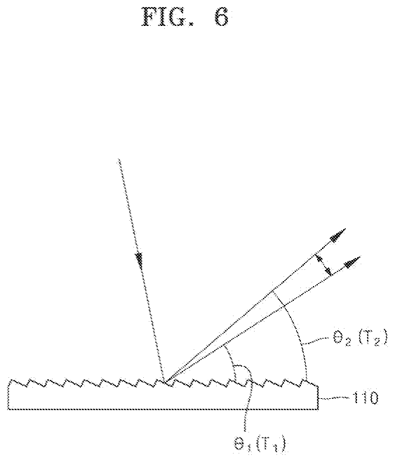

FIG. 6 is a diagram illustrating diffraction according to temperature of light in a grating layer 110 according to an example embodiment.

Referring to FIG. 6, light may be reflected and diffracted by the grating layer 110. A diffraction angle of diffracted light may be changed according to temperature. A diffraction angle of light in the grating layer 110 may be adjusted by changing the temperature of the grating layer 110. Because light is diffracted at different angles depending on temperatures T1 and T2, when the temperature changes, light diffracted from the grating layer 110 may be split at different angles θ1 and θ2.

A heater may be provided to change the temperature of the grating layer 110. The heater may apply heat to the grating layer 110 to change a refractive index of the grating layer 110 and change a diffraction angle of light in the grating layer 110 through the change in the refractive index of the grating layer 110.

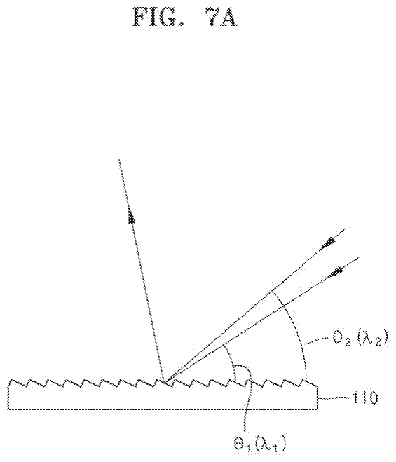

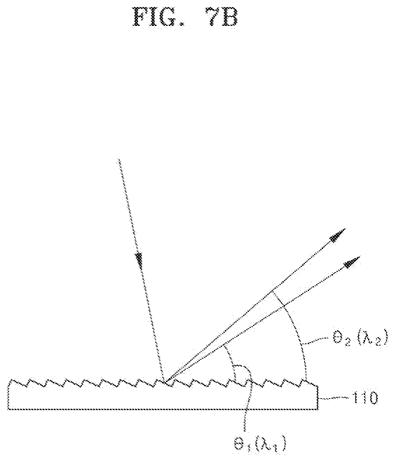

FIGS. 7A and 7B are diagrams illustrating diffraction according to a wavelength of light in a grating layer 110 according to an example embodiment.

Referring to FIG. 7A, light may be reflected and diffracted by the grating layer 110. When light of a plurality of wavelengths λ1 and λ2 is incident on the grating layer 110, the diffraction angle of the light may vary according to the wavelengths λ1 and λ2. Because the diffracted angles are different according to the wavelengths λ1 and λ2, respectively, light of different wavelengths incident on the grating layer 110 at different angles θ3 and θ4 may be diffracted at different angles from each other and emitted along one path. In this way, when light having a plurality of different wavelengths is multiplexed, the grating layer 110 may serve as a multiplexer. The multiplexer may include one of the grating structures 100, 101, 102, 103, and 104 of FIGS. 1 to 5.

Referring to FIG. 7B, light may be reflected and diffracted by the grating layer 110. When light having a plurality of different wavelengths λ1 and λ2 is incident on the grating layer 110, diffraction angles of the light having a plurality of wavelengths λ1 and λ2 may vary according to the wavelength. Because the diffraction angles are different according to the wavelengths λ1 and λ2, the light incident on one path may be emitted along a plurality of paths. In this way, when light having a plurality of different wavelengths λ1 and λ2 is divided into a plurality of paths, the grating layer 110 may serve as a demultiplexer. The demultiplexer may include one of the grating structures 100, 101, 102, 103, and 104 of FIGS. 1 to 5.

According to example embodiments, light having a plurality of wavelengths λ1 and λ2 may be diffracted by the grating layer 110 and divided into a plurality of paths. At this time, a diffraction angle of light divided into each path may be more precisely adjusted by changing the temperature of the grating layer 110 with a heater. In addition, the change in diffraction angle due to the temperature change of the surrounding environment may be compensated. The multiplexer and demultiplexer described above may be used in various optical devices, such as optical phased arrays and LiDAR devices.

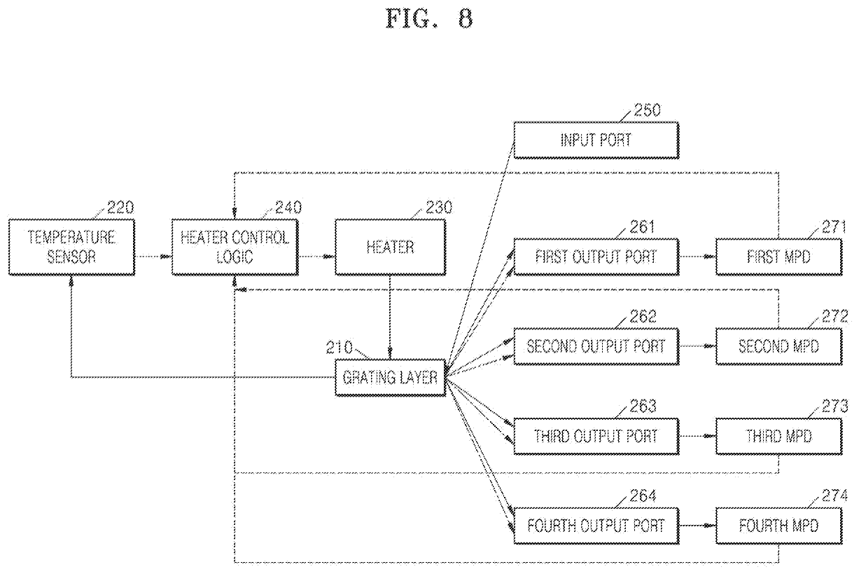

FIG. 8 is a diagram illustrating an example of temperature control in a demultiplexer 106 according to an example embodiment.

Referring to FIG. 8, the demultiplexer 106 may include a grating layer 210, a temperature sensor 220, a heater 230, a heater control logic (feedback control logic) 240, an input port 250 providing input light to the grating layer 210, a plurality of output ports 261, 262, 263, and 264 through which light diffracted at different angles is output from the grating layer 210, and a plurality of monitoring photodiodes (MPDs) 271, 272, 273, and 274 connected to the plurality of output ports 261, 262, 263, and 264. The demultiplexer 106 may control a temperature through the temperature sensor 220, the heater 230, the heater control logic 240, and the plurality of monitoring photodiodes 271, 272, 273, and 274.

In FIG. 8, a solid line indicates a feedback control process by the plurality of monitoring photodiodes 271, 272, 273, and 274, and a dashed dotted line indicates a feedback control process by the temperature sensor 220. Also, dotted lines indicate electrical signals for controlling the heater 230.

The temperature sensor 220 may detect a temperature change of the grating layer 210. The temperature sensor 220 may be disposed where the temperature sensor 220 is not affected by light. The temperature sensor 220 may be connected to the heater control logic 240. The change in resistance value according to a temperature change in the temperature sensor 220 may be transmitted to the heater control logic 240. The heater control logic 240 may detect a change in temperature of the grating layer 210 through the temperature sensor 220 and adjust the temperature through the heater 230 when there is a change in temperature. As the temperature of the grating layer 210 changes, a diffraction angle in the grating layer 210 may change. The heater control logic 240 may maintain the temperature of the grating layer 210 constant as the temperature obtained from the temperature sensor 220. Because the heater control logic 240 maintains a constant diffraction angle in the grating layer 210, the occurrence of crosstalk of a device may be prevented. As such, feedback control may be performed through the heater control logic 240.

A plurality of monitoring photodiodes 271, 272, 273, and 274 may be respectively connected to the plurality of output ports 261, 262, 263, and 264. The monitoring photodiodes 271, 272, 273, and 274 may monitor light of a waveguide by partially tapping the light. It is possible to detect whether a change in power occurs in each of the output ports 261, 262, 263, and 264 through each monitoring photodiode 271, 272, 273, and 274. The monitoring photodiodes 271, 272, 273, and 274 may be connected to the heater control logic 240. Changes in current values according to power changes in the monitoring photodiodes 271, 272, 273, and 274 may be transmitted to the heater control logic 240. When power changes, the power may be adjusted through the heater 230. For example, when the diffraction angle of light diffracted from the grating layer 210 changes, the power changes. Such a change in power may be sensed through each of the monitoring photo diodes 271, 272, 273, and 274. When the power is changed, the power can be adjusted by changing the diffraction angle of light through the heater 230. In this way, feedback control may be performed through the monitoring photodiodes 271, 272, 273, and 274.

Although FIG. 8 shows the configuration of the demultiplexer as an example, the configuration for temperature control shown in FIG. 8 may also be applied to a multiplexer. For example, the multiplexer may include a plurality of input ports and one output port instead of a single input port and a plurality of output ports of the demultiplexer.

As described above, the grating structure 100 may be applied to a multiplexer or a demultiplexer, and may be used in various optical devices, for example, an optical phased array device or a LIDAR device.

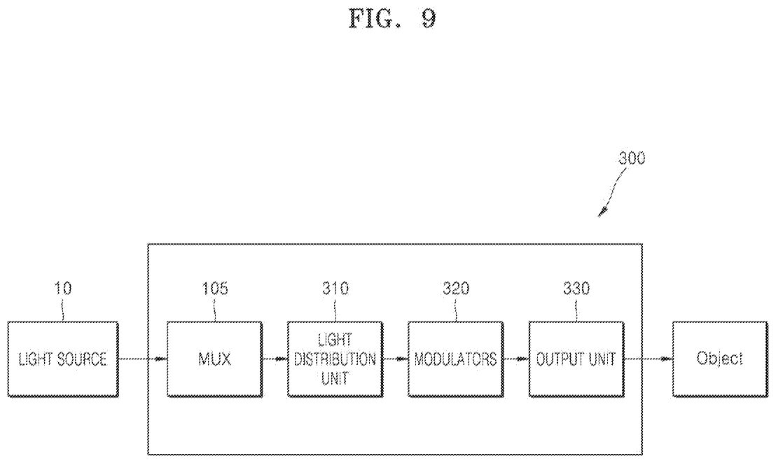

FIG. 9 is a diagram illustrating an optical phased array device 300 according to an example embodiment.

Referring to FIG. 9, the optical phased array device 300 includes a multiplexer 105 that receives and multiplexes light from the outside, an light distribution unit 310 (light distribution device 310) that distributes light passing through the multiplexer 105, a light modulator 320 for modulating multiplexed light distributed by the light distribution unit 310, and output units 330 (output devices 330) respectively connected to the light modulators 320 and emitting phase-adjusted lights.

The optical phased array device 300 may include a multiplexer 105 that simultaneously or sequentially receives and multiplexes light having a plurality of wavelengths generated from a light source 10. Hereinafter, a case in which light having a plurality of wavelengths is simultaneously provided to the multiplexer 105 will be described as an example. The multiplexer 105 may operate according to the principles described with reference to FIG. 7A. The multiplexer 105 may serve as an input coupler in the optical phased array device 300.

The optical phased array device 300 may include the light distribution unit 310 distributing light passing through the multiplexer 105. The light distribution unit 310 may branch a propagation path of light two or more times to form a plurality of channels, and may direct distributed sub-lights to a plurality of output ports. The light distribution unit 310 includes a plurality of branch points and may distribute input light into a plurality of sub-lights. The light distribution unit 310 may receive light and distribute the light to a plurality of waveguides. Each of the lights distributed by the light distribution unit 310 may have a multi-wavelength.

The light distribution unit 310 may include one or more splitters. In distributing light, the light distribution unit 310 may use splitters to distribute light in a 1:2 ratio by connecting the splitters in multiple stages. The light distribution unit 310 may be formed based on a waveguide, and a splitter may be disposed at each branch point. The light distribution unit 310 may be formed based on a multi-mode interference (MMI) type, and may be configured so that optical coupling loss and optical branching loss are less than or equal to a preset reference value. For example, the input light may pass through the light distribution unit 310 and be divided into 32 pieces of light by branching 5 times or split into 64 pieces of light by branching 6 times.

The light modulator 320 may modulate multiplexed light distributed by the light distribution unit 310. The light modulator 320 may be disposed between the light distribution unit 310 and the output unit 330. The light modulator 320 may be disposed in each channel to modulate phases of a plurality of sub lights. The light modulator 320 may modulate a phase of light distributed from the light distribution unit 310 to each waveguide. The light modulator 320 may modulate a phase of light passing through an active layer waveguide by applying any one of heat, light, current, voltage, and pressure to the active layer waveguide.

The output unit 330 may receive light from the light modulator 320 and emit a plurality of output lights to the outside at the same time. The plurality of output lights may have different wavelengths. The output unit 330 may include a plurality of grating patterns. Each grating pattern may emit light having a phase modulated by the light modulator 320, respectively. A propagation direction of the output light emitted by the output unit 330 may be determined according to a phase difference between the divided lights, a distance between the grating patterns, a height of the grating pattern, a width of the grating pattern, and a wavelength of the light. For example, an azimuth direction of output light may be determined according to the phase difference between the divided lights, and an elevation angle direction of the output light may be determined according to the wavelength of the light. Accordingly, a plurality of output lights having different wavelengths may be simultaneously emitted in different elevation angle directions.

The output unit 330 may include silicon. The output unit 330 may include various materials other than silicon. The output unit 330 may include a metal or an alloy. The output unit 330 may include, for example, a metal or an alloy including at least one of silver (Ag), gold (Au), aluminum (Al), and platinum (Pt). Also, the output unit 330 may include a metal nitride. The output unit 330 may include, for example, a metal nitride, such as titanium nitride (TiN) or tantalum nitride (TaN).

The optical phased array device 300 may include a plurality of optical amplifiers each disposed on the waveguide. The optical amplifier may be disposed in an optical path between the light distribution unit 310 and the light modulator 320 to amplify an amount of a plurality of sub-lights. For example, the optical amplifier may receive a current from an external power source and generate amplified light using energy of the provided current. The optical amplifier may be implemented as a Fabry-Perot amplifier (FPA) type or a traveling wave amplifier (TWA) type. For example, the optical amplifier may include a semiconductor optical amplifier or an ion-doped amplifier. Each of the plurality of optical amplifiers may amplify light distributed from the light distribution unit 310 with the same gain, but embodiments are not limited thereto. Each of the plurality of optical amplifiers may amplify light distributed from the light distribution unit 310 with different gains.

The optical phased array device 300 may include a plurality of optical waveguides that sequentially transfer light generated from the light source 10 to the multiplexer 105, the light distribution unit 310, the light modulator 320, and the output unit 330. For example, an optical connection between the multiplexer 105, the light distribution unit 310, the light modulators 320, and the output unit 330 may be formed in an optical waveguide-based structure. A general semiconductor or insulator material may be used as the optical waveguide. The waveguide may include a rib waveguide having one vertical protrusion, a rib waveguide having a plurality of vertical protrusions, or a channel waveguide having no protrusion.

Beam steering in a direction perpendicular to a propagation direction of the waveguide is possible by multiplexing and using light emitted from a light source that generates light having a plurality of wavelengths with the multiplexer 105, and by performing a phase modulation of light in the light modulator 320, beam steering in a horizontal direction is possible, and thus, a beam steering in two dimensions may be possible.

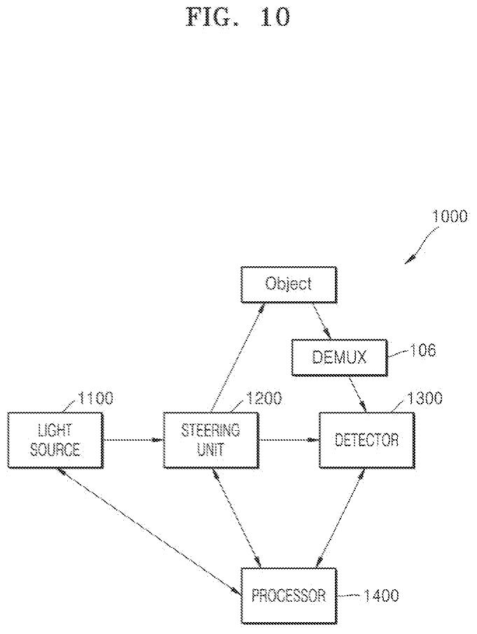

FIG. 10 is a diagram showing a LIDAR device 1000 according to an example embodiment.

As shown in FIG. 10, the LiDAR device 1000 includes a light source 1100 that generates light, a steering unit 1200 that steers light output from the light source 1100 toward an object, a detector 1300 detecting light reflected from the object, and a processor 1400 performing an operation for obtaining information on an object from the light detected by the detector 1300. The LiDAR device 1000 may further include a plurality of waveguides providing optical connection between the light source 1100 and the steering unit 1200 and between the steering unit 1200 and the detector 1300, respectively. The light source 1100, the steering unit 1200, the detector 1300, and the processor 1400 may be implemented as separate devices or as one device.

The light source 1100 may be a tunable laser light source that may adjust a wavelength of emitting light. Light having a plurality of wavelengths may be emitted from the light source 1100 and may be incident to the steering unit 1200. The light source 1100 may generate and output light of a plurality of different wavelength bands. In addition, the light source 1100 may generate and output pulsed light or continuous light.

The light source 1100 may include a laser diode (LD), an edge emitting laser, a vertical-cavity surface emitting laser (VCSEL), a distributed feedback laser, a light emitting diode (LED), a super luminescent diode (SLD), and the like.

The light source 1100 may be directly coupled (on-chip) or indirectly coupled (off-chip) to the waveguide. An on-chip light source may be implemented through III-V bonding or epitaxial growth. An off-chip light source may be implemented using vertical coupling, edge coupling, or chip alignment of an external light source.

The steering unit 1200 illuminates an object by changing a propagation direction of light output from the light source 1100, and may include an optical phased array device that may adjust the direction of light without mechanical movement. The optical phased array device may be the same as the optical phased array device 300 of FIG. 9. The steering unit 1200 may transmit amplified light toward a localized forward region in a one-dimensional (1D) or two-dimensional (2D) scanning method. To this end, the steering unit 1200 may sequentially or non-sequentially steer light focused in a narrow region to front 1D or 2D regions at regular time intervals. For example, the steering unit 1200 may be configured to emit laser light from bottom to top or from top to bottom with respect to one-dimensional regions in front of the steering unit 1200. In addition, the steering unit 1200 may be configured to emit laser light from left to right or from right to left with respect to one-dimensional areas in front of the steering unit 1200.

The detector 1300 may detect light reflected by an object and generate an electrical signal based on the detected light. The detector 1300 may include an array of light detection elements. The detector 1300 may further include a spectroscopic device for analyzing light reflected from an object by wavelength.

The processor 1400 may perform an operation for obtaining information about an object from the light detected by the detector 1300. In addition, the processor 1400 may oversee processing and control of the entire LiDAR device 1000. The processor 1400 may acquire and process information about an object. For example, the processor 1400 may acquire and process 2D or 3D image information. The processor 1400 may generally control the driving of the light source 1100 and the steering unit 1200 or the operation of the detector 1300. For example, the processor 1400 may control an electrical signal applied to an optical phased array device included in the steering unit 1200. The processor 1400 may also analyze a distance between an object and the LiDAR apparatus 1000, the shape of the object, and the like through the numerical information provided by the detector 1300.

A 3D image acquired by the processor 1400 may be transmitted to and utilized by another unit. For example, such information may be transmitted to the processor 1400 of an autonomous driving device, such as a vehicle or a drone in which the LiDAR device 1000 is employed. In addition, such information may be utilized in smart phones, mobile phones, personal digital assistants (PDAs), laptops, personal computers (PCs), wearable devices, and other mobile or non-mobile computing devices.

The LiDAR device 1000 may further include a demultiplexer 106. The demultiplexer 106 may include one of the grating structures 100, 101, 102, 103, and 104 of FIGS. 1 to 5. For example, the demultiplexer 106 may have a structure shown in FIG. 8. The demultiplexer 106 may demultiplex light reflected from an object so that light having a plurality of wavelengths is divided into and propagate to a plurality of paths. Through this operation, only light corresponding to the wavelength of light emitted from the light source 1100 may be provided to the detector 1300. According to another example embodiment, when the light source 1100 emits light of a plurality of wavelengths, the processor 1400 may obtain and process information about an object based on each wavelength.

Although the object is shown as a simple structure for convenience, this is an example, and its shape, size, structure, etc. may be variously changed. The type of object is not limited, and any object existing in a certain space or space may correspond the object.

The LiDAR device 1000 according to embodiments may be applied to, for example, smart phones, mobile phones, personal digital assistants (PDAs), laptops, personal computers (PCs), or wearable devices. For example, a smart phone may extract depth information of objects in an image, adjust out-of-focusing of an image, or automatically identify objects in an image by using the LiDAR device 1000, which is an object 3D sensor.

In addition, the LiDAR device 1000 according to embodiments may be applied to a vehicle. A vehicle may include a plurality of LiDAR devices 1000 disposed in various locations. The vehicle may provide various information about the inside or surroundings of the vehicle to the driver using the LiDAR device 1000, and may automatically recognize objects or people in the image to provide information necessary for autonomous driving.

The grating structure according to an example embodiment includes a heater disposed on a grating layer to obtain a desired diffraction angle by adjusting the diffraction angle according to temperature, thereby improving thermal performance.

According to example embodiments according to the technical scope of the disclosure, it may be confirmed that a grating structure with improved thermal performance and a LIDAR device including the same may be provided. The grating structure and the LiDAR device including the grating structure have been described with reference to the embodiment shown in the drawings, but embodiments are not limited thereto. It will be understood by those of ordinary skill in the art that various changes in form and details may be made therein without departing from the spirit and scope of the disclosure. Therefore, the embodiments should be considered in descriptive sense only and not for purposes of limitation. The scope of the disclosure is defined not by the detailed description of the disclosure but by the appended claims, and all differences within the scope will be construed as being included in the disclosure.

It should be understood that embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims and their equivalents.

What is claimed is:

1. A grating structure comprising:
a grating layer comprising a first surface, a second surface opposite to the first surface, and a plurality of grating teeth between the first surface and the second surface;
a slab layer on a surface of at least one of the plurality of grating teeth; and
a heater on at least one of the first surface, the second surface, and the plurality of grating teeth.

2. The grating structure of claim 1, wherein the heater is on a portion of the first surface or a portion of the second surface in contact with the plurality of grating teeth.

3. The grating structure of claim 2, wherein the heater comprises a plurality of heaters corresponding to the plurality of grating teeth, respectively.

4. The grating structure of claim 1, wherein the heater is between the slab layer and the plurality of grating teeth.

5. The grating structure of claim 4, wherein the heater comprises a coating layer, comprising a dielectric material, dividing the heater.

6. The grating structure of claim 1, wherein the heater comprises nickel (Ni), tantalum (Ta), platinum (Pt), gold (Au), silver (Ag), titanium (Ti), aluminum (Al), copper (Cu), or tungsten (W).

7. The grating structure of claim 1, wherein the heater has a thickness equal to or less than 1.5 μm.

8. The grating structure of claim 1, wherein a refractive index of a material of the grating layer is less than a refractive index of a material of the slab layer.

9. The grating structure of claim 1, wherein the grating layer comprises an echelle grating.

10. An optical phased array device comprising:
a multiplexer configured to receive and multiplex light;
a light distribution device configured to distribute the light passing through the multiplexer;
a light modulator configured to modulate the multiplexed light distributed by the light distribution device; and
an output device configured to receive light from the light modulator and simultaneously emit a plurality of output lights,
wherein the multiplexer comprises:
a grating layer comprising a first surface, a second surface opposite to the first surface, and a plurality of grating teeth between the first surface and the second surface;
a slab layer on a surface of at least one of the plurality of grating teeth; and
a heater on at least one of the first surface, the second surface, and the plurality of grating teeth.

11. The optical phased array device of claim 10, wherein the heater is on a portion of the first surface or a portion of the second surface in contact with the plurality of grating teeth.

12. The optical phased array device of claim 11, wherein the heater comprises a plurality of heaters corresponding to the plurality of grating teeth, respectively.

13. The optical phased array device of claim 10, wherein the heater is between the slab layer and the plurality of grating teeth.

14. The optical phased array device of claim 10, wherein the multiplexer, the light distribution device, the light modulator, and the output device are optically connected.

15. A light detection and ranging (LiDAR) device comprising:
a light source;
a steering device;
a detector; and
a processor,
wherein the steering device comprises an optical phased array device that comprises:
a multiplexer configured to receive and multiplex light from the light source;
a light distribution device configured to distribute the light passing through the multiplexer;
a light modulator configured to modulate the multiplexed light distributed by the light distribution device; and
an output device configured to receive light from the light modulator and simultaneously emit a plurality of output lights,
wherein the multiplexer comprises:
a grating layer comprising a first surface, a second surface opposite to the first surface, and a plurality of grating teeth between the first surface and the second surface;
a slab layer disposed on a surface of at least one of the plurality of grating teeth; and
a heater on at least one of the first surface, the second surface, and the plurality of grating teeth of the grating layer.

16. The LiDAR device of claim 15, further comprising a demultiplexer,
wherein the demultiplexer is configured to demultiplex the light reflected from an object and divide the light into light having different wavelengths.

17. The LiDAR device of claim 15, wherein the heater is on a portion of the first surface or a portion of the second surface in contact with the plurality of grating teeth.

18. The LiDAR device of claim 17, wherein the heater comprises a plurality of heaters corresponding to the plurality of grating teeth, respectively.

19. The LiDAR device of claim 15, wherein the heater is between the slab layer and the plurality of grating teeth.

20. The LiDAR device of claim 19, wherein the heater comprises a coating layer, comprising a dielectric material, dividing the heater.
